(19) United States
(12) Patent Application Publication
(10) Pub. No.: US 2006/0183552 A1
(43) Pub. Date: Aug. 17, 2006

(54) System & method for data mining

(76) Inventor: Carmen DiMichele, Sparks, NV (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/056,503

(22) Filed: Feb. 11, 2005

(51) Int. Cl. G06F 17/00

(52) U.S. Cl. 463/43

(57) ABSTRACT

A system and method for mining data stored in a casino gaming system is provided. A data search for data stored in the casino gaming system is initiated. The casino gaming system comprises one or more than one component connected via a network, and the one or more than one component comprises one or more than one data repository for storing data. One or more of the components comprises different communication protocols. Each appropriate communication protocol needed for interfacing with one or more of the components to search for data stored in one or more data repositories of the components is determined. Data in one or more than one data repository is searched and retrieved. The results of the data search may then be provided in some predetermined format.

### BACKGROUND

Today, typical casino gaming systems are comprised of numerous types of components connected together via a network. These types of components include servers, gaming machines, networking equipment and gaming machine control devices. In numerous modern systems, many of the various types of components include one or more data repositories for storing data. Typically, the stored data is information relating to the casino gaming system.

Traditionally, a portion of the data from these various components of the casino gaming system is collected and stored in one location. Specifically, pre-determined types of data are periodically retrieved from particular casino gaming system components. The retrieved data is then stored in a centralized database. The data stored in this central database may be searched and used to generate reports and other information.

Since the periodic retrieval of data from the data repositories only collects a portion of the data, the centralized database is not a complete compilation of all of the data in the casino gaming system. Further, since the retrieval process occurs at periodic intervals, the data in the centralized database is seldom current.

Presently, in casino gaming systems, the scope of most data searches is limited to querying only the centralized database. This limitation on the scope of the data search is due to the complex and difficult nature in issuing successful queries for the entire casino gaming system. For example, many of the various types of casino gaming system components use different communication protocols. Interfacing with the many types of components requires the ability to use a copious amount of different protocols. Additionally, the data in the data repositories of the components is stored in a variety of formats, which must be known in order to access and search the data. The many different communication protocols and data formats present in the system, requires the use of several different forms of data retrieval for accessing the data. Since these many different forms of data retrieval are seldom known by any one researcher, it becomes very difficult to truly have access to all of the data stored in the casino gaming system.

What is needed is a method and system for making data more accessible and to enable the search of data beyond the centralized database. More particularly, what is needed is a method and system for searching and retrieving casino gaming system data stored in non-centralized locations.

### SUMMARY

Briefly, and in general terms, there is provided a system and method for mining data stored in a casino gaming system. The method comprises initiating a data search in a casino gaming system, wherein the casino gaming system comprises one or more than one component connected via a network, and one or more than one component comprises one or more than one data repository for storing data. One or more than one component comprises a different communications protocol. To search for data stored in the one or more than one data repository, an appropriate communication protocol for interfacing with the one or more than one component is determined. Then the data stored in the data repository is searched and data is retrieved.

In another embodiment a system for mining data stored in a casino gaming system is provided. The system comprises a data management component connected to the casino gaming system. The data management component manages the search of data. A protocol determining component is connected to the data management component and determines the appropriate communication protocol necessary for interfacing with one or more components of a casino gaming system. An intelligent agent is connected to at least one of the data management component and the protocol determining component.

Another embodiment provides for a method for mining data stored in a system. The method comprises initiating a data search in the system. The system comprises one or more than one component connected via a network, and one or more than one of the components comprise one or more than one data repository for storing data. One or more than one of the components comprise a different communications protocol. To search for data stored in the one or more than one data repository, the appropriate communication protocol for interfacing with one or more than one component is determined. The data repositories are then searched for data and data is retrieved from the one or more than one data repository.

### BRIEF DESCRIPTION OF DRAWINGS

FIG. 1 is a schematic illustration of a casino gaming system for use in accordance with an embodiment of the invention.

FIG. 2 is a flow diagram illustrating the steps performed in a method for mining data in a casino gaming system in accordance with an embodiment of the invention.

FIG. 3 is an illustration of a data mining tool for use in accordance with an alternative embodiment of the invention.

### DETAILED DESCRIPTION

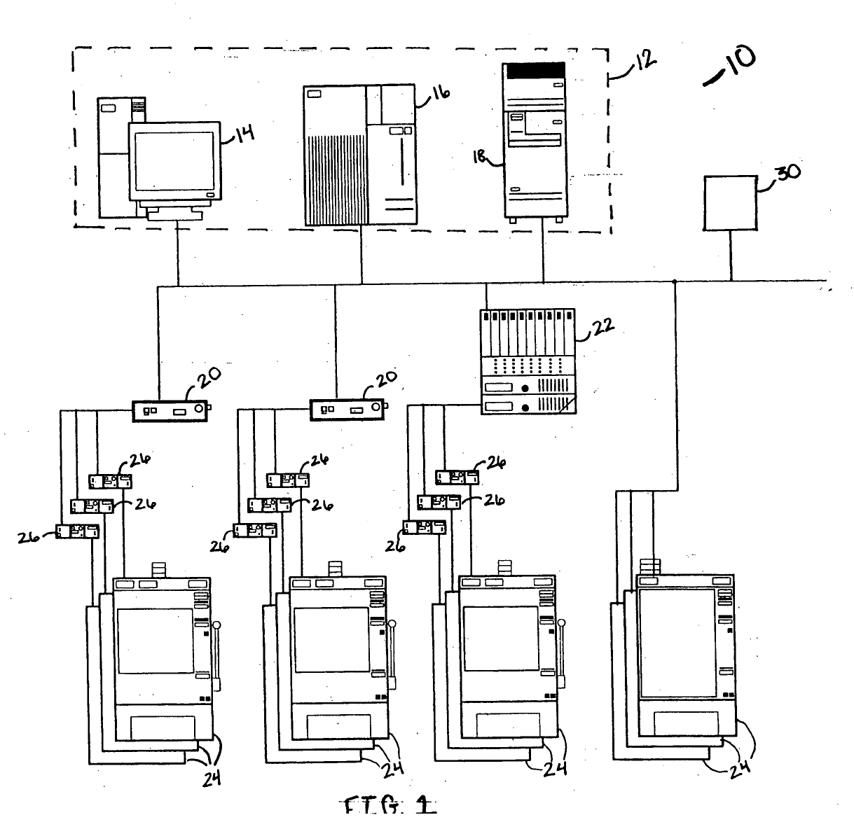

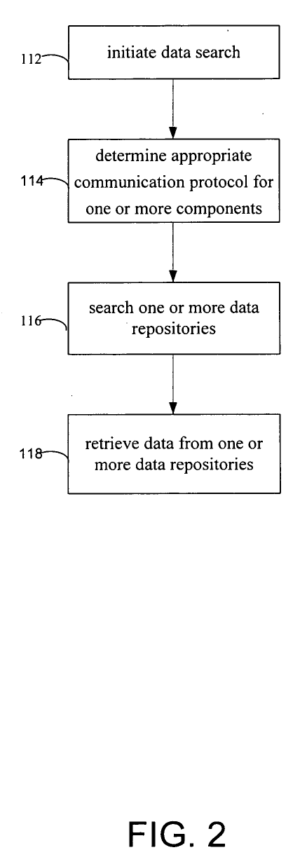

The invention is directed to a system and method for mining data in a casino gaming system. The system and method provide a more efficient and more expansive way to retrieve data. Additionally, the system and method provide less duplication of data and offer more ways to retrieve data. Embodiments of the system and method are illustrated and described herein, by way of example only, and not by way of limitation. Referring now to the drawings, wherein like reference numerals denote like or corresponding parts throughout the drawings and, more particularly to FIGS. 1-2, there is shown an example of mining data stored in a casino gaming system.

Referring to FIG. 1, a casino gaming system 10 is shown. The casino gaming system 10 comprises a server system 12, network bridges 20, a network rack 22, gaming machines 24 and game management units 26 all connected via a system network.

A variety of types of servers may be used as the system server 12. The type of server used is generally determined by the platform and software requirements of the gaming system. Additionally, the gaming system server may be configured to comprise multiple servers. In one embodiment, as illustrated in FIG. 1, the server system 12 is configured to include three servers. Specifically, servers 14, 16 and 18 form the server system 12, or the back-end servers. In one example, server 14 is a windows based server, server 16 is an IBM RS6000 based server, and server 18 is an IBM AS/400 based server. Of course, one of ordinary skill in the art will appreciate that different types of servers may also be used. The server system 12 performs several fundamental functions. For example, the server system 12 can collect data from the slot floor as communicated to it from other network components, and maintain the collected data in its database. The server system 12 may use slot floor data to generate a report used in casino operation functions. Examples of such reports include, but are not limited to, accounting reports, security reports, and usage reports. The system server 12 may also pass data to another server for other functions. Alternatively, the system server 12 may pass data stored on its database to floor hardware for interaction with a game or slot player. For example, data such as a game player's name or the amount of a ticket being redeemed at a game, may be passed to the floor hardware. Additionally, the system server 12 may comprise one or more data repositories for storing data. Examples of types of data stored in the system server data repositories include, but are not limited to, information relating to individual player play data, individual game long-term accounting data and cashable ticket data.

The network bridges 20 and network rack 22 shown in FIG. 1 are networking components. These networking components, which may be classified as middleware, facilitate communications between the system server 12 and the game management units 26. The network bridges 20 concentrate the many game management units 26 (2,000 on average) into a fewer number (nominally 50:1) of connections to the system server 12. Additionally, the network rack 22 may also concentrate game management units 26 into a fewer number (2000:1) of connections to the system server 12. The network bridges 20 and network rack 22 may comprise data repositories for storing network performance data. Such performance data may be based on network traffic and other network related information.

Optionally, a network bridge 20 and a network rack 22 may be interchangeable components. For example, in one embodiment, a casino gaming system may comprise only network bridges and no network racks. Alternatively, in another embodiment, a casino gaming system may comprise only network racks and no network bridges. Additionally, in an alternative embodiment, a casino gaming system may comprise any combination of one or more network bridges and one or more network racks.

The gaming machines 24 illustrated in FIG. 1 act as terminals for interacting with a player playing a casino game. The gaming machines may be any casino-type game, which may include, but is not limited to mechanical slot machines and video game machines, such as video slots and video poker. Additionally, each gaming machine 24 may comprise one or more data repositories for storing data. Examples of information stored by the gaming machines 24 include, but are not limited to, maintenance history information, long-term play data and real-time play data.

Game management units (GMUs) connect gaming machines to network bridges. The function of the GMU is similar to the function of a network interface card connected to a desktop PC. Referring to FIG. 1, a GMU 26 connects a gaming machine 24 to the network bridge 20. Some GMUs have much greater capability and can perform such tasks as calculating a promotional cash-back award for a player, generating a unique ID for a cash redeemable ticket, and storing limited amounts of game and transaction based data. Some GMUs may comprise one or more data repositories for storing data. The types of data stored by the GMUs may include, but is not limited to, real-time game data, communication link performance data and real-time player play data.

In one embodiment, the GMU 26 is a separate component located outside the gaming machine. Optionally, in another embodiment, the GMU 26 is located within the gaming machine.

Of course, one of ordinary skill in the art will appreciate that a casino gaming system may also comprise other types of components, and the above illustration is meant only as an example and not as a limitation to the types of components used in a casino gaming system.

The components of the casino gaming system (e.g. the system server 12, network bridges 20, network rack 22, gaming machines 24 and game management units 26) each use particular communication protocols. To interface with a component, the appropriate or compatible communication protocol of the component must be used. In order to access and mine the data stored in the data repositories of the components, a wide variety of protocols and techniques is required.

In one embodiment, a data mining tool is used to access and mine the data stored in the casino gaming system components. Referring to FIG. 1, a data mining tool 30 is shown. The data mining tool determines the appropriate protocol necessary for use in communicating with a particular component. The data mining tool then interfaces with the component to access data stored in the data repositories of the components. This allows the data mining tool to search and retrieve relevant data. Additionally, the data mining tool determines a set of appropriate protocols necessary for use in communicating with more than one component. This allows the data mining tool to use each appropriate protocol when interfacing with more than one component.

Alternatively, the data mining tool determines a method for communicating with one or more components. The method may use multiple protocols, such that the appropriate protocol is used to communicate with each of the one or more components. In one example, referring back to FIG. 1, the system server 12 needs to obtain data from a gaming machine 24. The data stored in the gaming machine 24 must be accessed from the system server 12 by going through the middleware (such as network bridge 20 and/or network rack 22). The data mining tool determines a set of protocols for interfacing with several components such as a network bridge 20 and a gaming machine 24.

Optionally, in another embodiment, once the data mining tool has searched and retrieved relevant data, the data is organized. The organized data may then be provided to a user in some fashion.

For example, in one embodiment, a summary may be created of the organized data. The summary may be used to generate a report, wherein the report may be provided to a user. Optionally, the summary may be stored for later use.

Alternatively, in another embodiment, a user may view the retrieved data presented in a provided user interface module. The data may be presented in the form of a report, in a graphical representation such as a chart, or any other presentation format.

Optionally, in another embodiment, optimization calculations are performed on the retrieved data. The results of the optimization calculations may then be reported in the form of a report, in a graphical representation such as a chart, or any other presentation format.

In another embodiment, the retrieved data is parsed for links between the data. Additionally, the retrieved data may also be indexed.

The data mining tool may comprise any combination of one or more data mining robots, data mining spiders, data mining crawlers or other web crawler technology. Robots (bots), spiders and crawlers may be used to collect, index and maintain data from a distributed set of data repositories. Additionally, bots, spiders and crawlers are capable of collecting data randomly and also collecting data based on prior search information obtained from data previously collected. The retrieved data is indexed and placed in an organized form that is easily searchable. This organized form of data lends itself to many uses, including the viewing of events from different perspectives.

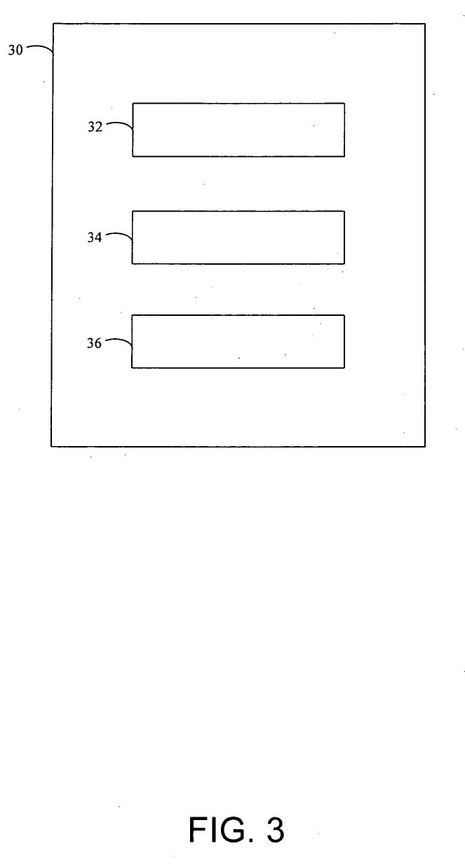

Alternatively, the data mining tool 30 may comprise one or more components. For example, referring to FIG. 3, a data mining tool 30 comprises a data management component 32, a protocol determining component 34 and an intelligent component 36. The data management component 32 manages and oversees the organization of the retrieved data and the providing of the results of data search based upon the retrieved data. Additionally, the data management component manages the creation of a summary of the retrieved data.

The protocol determining component 34 determines the appropriate communication protocol necessary for interfacing with one or more components of a casino gaming system. The intelligent component 36 acts as an intelligent agent and is useful in improving data mining. For example, the intelligent agent uses cross indexes to enhance data retrieval. Examples of an intelligent agent include but are not limited a data mining robot, a data mining spider, and a web crawler.

Of course, one of ordinary skill in the art will appreciate that the data mining tool may comprise a various number of components. Additionally, one of ordinary skill in the art will appreciate that the components of the data mining tool may be connected, via a network, to the casino gaming system in a multitude of ways.

Referring back to FIG. 1, the data mining tool 30 is shown as a separate component connected to the casino gaming system 10. Alternatively, the data mining tool 30 may be a component placed within the server system 12 (not shown). Optionally, the data mining tool 30, may comprise one or more components, where the components are physically separated, but still connected via the network, and are placed in various positions within the casino gaming system 10.

An example of a use for the data mining tool 30 is in gaming floor optimization. Gaming floor optimization considers such issues as the placement of less played games so that they are played more frequently, which game denominations make the most sense in which games/locations, and which casino events trigger the most play on which part of the floor. In the past, gaming floor optimization was limited and difficult to successfully accomplish due to the very particular ways in which gaming data was organized. However, the data mining tool permits the data stored in the data repositories to be cross-referenced, searchable, and/or collaborative, thus promoting gaming floor optimization. An example of a query for use in gaming floor optimization could be “what was happening during the concert last night?” An example of the results could be: “most quarter games got 20% more play, overall floor network traffic was up by 5%, ticket usage was 107% of the average, more promotional credits were used than ever before, etc.”

One example of an embodiment for mining data stored in a casino gaming system is illustrated in the flowchart shown in FIG. 2. Referring to FIG. 2, in a first Step 1112, a data search is initiated.

In one embodiment, the data search is initiated by issuing a data query. Referring back to FIG. 1, the data query may be issued from any of the casino gaming system components, such as the system server 12, the network bridge 20, the network rack 22, the game management unit 26 or the gaming machine 24. Optionally, in an alternative embodiment, not all of the components have the ability to issue a data query. For example, in a separate embodiment, only the system server 12 may be used to issue a data query. Alternatively, in a different embodiment, a data query may be issued from some of the gaming machines 24, but not all of the gaming machines 24.

Of course, one of ordinary skill in the art will appreciate numerous combinations of components may be devised, in which particular components enable data queries, and other components cannot enable data queries. As such, the above illustrative embodiments are only a few examples of the many possibilities for issuing a data query.

Referring back to the flowchart in FIG. 2, in Step 114, the appropriate communication protocol for interfacing with a component is determined. In one embodiment, a data mining tool is used to determine the appropriate communication protocol necessary to interface with each component.

The data mining tool explores and analyzes the stored data to uncover patterns and relationships contained within the casino gaming system activity and history.

Next, in Step 116, after determining the appropriate communication protocol of a component, the data repository of the component is searched. In Step 118, data from the data repository is retrieved. The retrieved data is organized and is fully searchable.

An illustrative example of the above described method follows. In this example, a user initiates a data search by issuing a query for game metering information between specific dates. The data mining tool receives the query and issues a request for data. The request is sent throughout the casino gaming system using appropriate communication protocols for interfacing with the various components of the casino gaming system. Thus allowing the data repositories of the components to be searched. Data applicable to query is then retrieved and provided to the user issuing the initial query.

Additionally, in another embodiment, a processing step is performed before issuing a data query. For example, processing steps such as determining how to summarize data from many pieces could, or determining how to provide data to a user are processes that could occur before a data query is issued.

Additionally, in an alternative embodiment the data mining tool may be used with a system other than a casino gaming system. For example, the data mining tool is suitable for use with a banking system, an insurance system, or any other data system which compiles and stores data.

Furthermore, the various methodologies described above are provided by way of illustration only and should not be construed to limit the invention. Those skilled in the art will readily recognize that various modifications and changes may be made to the present invention without departing from the true spirit and scope of the present invention. Accordingly, it is not intended that the present invention be limited, except as by the appended claims.

What is claimed is:

1. A method for mining data stored in a casino gaming system, the method comprising:
initiating a data search in the casino gaming system, wherein the casino gaming system comprises one or more than one component connected via a network, and one or more than one component comprises one or more than one data repository for storing data;
determining an appropriate communication protocol for interfacing with one or more than one component to search for data stored in the one or more than one data repository, wherein one or more than one component comprises a different communications protocol;
searching for data in one or more than one data repository; and
retrieving data from one or more than one data repository.

2. The method of claim 1, further comprising determining more than one appropriate communication protocol for interfacing with more than one component.

3. The method of claim 1, further comprising, providing the results of the data search based on the retrieved data.

4. The method of claim 1 further comprising, organizing the retrieved data.

5. The method of claim 4, wherein organizing the data further comprises indexing the data.

6. The method of claim 4 further comprising, creating a summary of the organized data.

7. The method of claim 6 further comprising, storing the summary of the organized data.

8. The method of claim 6 further comprising, reporting the summary of the organized data.

9. The method of claim 1 further comprising, after retrieving the data, performing one or more optimization calculations on the retrieved data.

10. The method of claim 9 further comprising, reporting the results of the optimization calculations performed on the retrieved data.

11. The method of claim 1 further comprising, after retrieving the data, parsing the data for links between the data.

12. The method of claim 1 further comprising, providing a user interface module for presenting the retrieved data in different forms.

13. The method of claim 12 wherein the retrieved data is presented in the format of a graphical representation.

14. The method of claim 1 further comprising, issuing a query before searching the data.

15. The method of claim 1, wherein initiating a data search further comprises using a data mining tool to search for data stored in the data repositories.

16. The method of claim 15, wherein the data mining tool determines the appropriate communication protocol for interfacing with one or more than one component.

17. The method of claim 15, wherein the data mining tool comprises a data mining robot.

18. The method of claim 15, wherein the data mining tool comprises a data mining spider.

19. The method of claim 15, wherein the data mining tool comprises web crawler technology.

20. The method of claim 19 wherein a web crawler retrieves stored data from one or more than one data repository.

21. The method of claim 1 further comprising, using the retrieved data for casino gaming floor optimization.

22. The method of claim 1 wherein searching for data further comprises searching data external to the casino gaming system.

23. A system for mining data stored in a casino gaming system, the system comprising:
a data management component for managing the search of data, wherein the data management component is connected to the casino gaming system;
a protocol determining component connected to the data management component, wherein the protocol determining component determines the appropriate communication protocol necessary for interfacing with one or more components of a casino gaming system; and
an intelligent agent connected to at least one of the data management component and the protocol determining component.

24. The system of claim 23, wherein the intelligent agent comprises a data mining robot.

25. The system of claim 23, wherein the intelligent agent comprises a data mining spider.

26. The system of claim 23, wherein the intelligent agent comprises web crawler technology.

27. A method for mining data stored in a system having at least one data repository for storing data, the method comprising:
initiating a data search in the system, wherein the system comprises one or more than one component connected via a network, and one or more than one component comprises one or more than one data repository;
determining an appropriate communication protocol for interfacing with one or more than one component to search for data stored in the one or more than one data repository, wherein one or more than one component comprises a different communications protocol;
searching for data in one or more than one data repository; and
retrieving data from one or more than one data repository.
